(19) United States
(12) Patent Application Publication
(10) Pub. No.: US 2021/0066005 A1
(43) Pub. Date: Mar. 4, 2021

(54) KEYBOARD DEVICE

(71) Applicant: Primax Electronics Ltd., Taipei (TW)

(72) Inventors: Ming-Han Wu, Taipei (TW); Yi-Wei Chen, Taipei (TW); Che-Wei Yang, Taipei (TW)

(21) Appl. No.: 16/662,704

(22) Filed: Oct. 24, 2019

(30) Foreign Application Priority Data
Aug. 30, 2019 (TW) 108131386

(51) Int. Cl. H01H 13/83; H01H 13/7065; H01H 13/85

(52) U.S. Cl. CPC H01H 13/83; H01H 2219/044; H01H 13/85; H01H 13/7065

(57) ABSTRACT

A keyboard device includes plural key structures, a membrane circuit board and a flexible light shielding element. Each key structure includes a keycap. The keycap has a first end surface and a second end surface. The membrane circuit board is located under the keycap. The flexible light shielding element is arranged between the keycap and the membrane circuit board, and includes a bottom layer and plural stopping walls. Each stopping wall includes a wall body and a platform part. The wall body is protruded from the bottom layer and in the direction toward the keycap. An included angle is formed between the wall body and the bottom layer. The platform part is protruded from the wall body. The platform part is arranged between the second end surface of the keycap and the bottom layer. The platform part is contacted with the second end surface.

### FIELD OF THE INVENTION

The present invention relates to an input device, and more particularly to a keyboard device with plural keys.

### BACKGROUND OF THE INVENTION

With increasing development of science and technology, a variety of electronic devices are designed in views of convenience and user-friendliness. For helping the user well operate the electronic devices, the electronic devices are gradually developed in views of humanization. The common electronic devices include for example mouse devices, keyboard devices, trackball devices, or the like. Via the keyboard device, characters or symbols can be inputted into the computer system directly. As a consequence, most users and most manufacturers of input devices pay much attention to the development of keyboard devices.

With increasing development of keyboard devices, a keyboard device with a backlight module has been introduced into the market. The keyboard device with the backlight module is also referred as a luminous keyboard. When the luminous keyboard is used in an indoor lighting environment such as an office or a room, the human eyes can obviously recognize that the light beams from a bottom side of the luminous keyboard illuminate all keys of the luminous keyboard. Consequently, a visual effect is generated.

In views of cost-effectiveness, a backlight module of the keyboard device is equipped with a light guide plate to illuminate the entire of the keyboard device. In other words, the purposes of illuminating the key regions but not illuminating the non-key regions cannot be achieved according to the conventional technology. For achieving the purposes of illuminating the key regions but not illuminating the non-key regions, it is necessary to install one light-emitting element (e.g., a light emitting diode) under each key. However, the arrangement of so many light-emitting elements largely increases the fabricating cost.

Therefore, there is a need of providing an improved membrane keyboard device in order to overcome the above drawbacks.

### SUMMARY OF THE INVENTION

An object of the present invention provides a keyboard device. The keyboard device includes a flexible light shielding element with plural stopping walls. Due to the stopping walls, the light beam from a backlight module is only allowed to be outputted from the keycap. The plural stopping walls are contacted with a keycap. Consequently, the tactile feel of depressing the keycap is enhanced.

The other objects and advantages of the present invention will be understood from the disclosed technical features.

In accordance with an aspect of the present invention, a keyboard device is provided. The keyboard device includes plural key structures, a membrane circuit board and a flexible light shielding element. Each of the key structures includes a keycap. The keycap has a first end surface and a second end surface, which are opposed to each other. The membrane circuit board is located under the keycap. The flexible light shielding element is arranged between the keycap and the membrane circuit board, and includes a bottom layer and plural stopping walls. Each of the stopping walls includes a wall body and a platform part. The wall body is protruded from the bottom layer and in the direction toward the keycap. An included angle is formed between the wall body and the bottom layer. The platform part is protruded from the wall body. The platform part is arranged between the second end surface of the keycap and the bottom layer. The platform part is contacted with the second end surface of the keycap.

In an embodiment, the included angle between the wall body and the bottom layer is in a range between 30 degrees and 50 degrees.

In an embodiment, the platform part has a contact surface, and the contact surface is in parallel with the second end surface of the keycap. The contact surface of the platform part is contacted with the second end surface of the keycap.

In an embodiment, the platform parts of the plural stopping walls are included in an orthographic projection region of the keycap with respect to the bottom layer, and the wall bodies of the plural stopping walls are located outside the orthographic projection region.

In an embodiment, the bottom layer and the plural stopping walls of the flexible light shielding element are integrally formed as a one-piece structure.

In an embodiment, the flexible light shielding element is made of silicon resin.

In an embodiment, the wall bodies of the plural stopping walls comprise a first wall body, a second wall body, a third wall body and a fourth wall body, which are connected with each other. The first wall body and the second wall body are opposed to each other. The third wall body and the fourth wall body are opposed to each other. The third wall body and the first wall body are connected with each other at a first junction. The fourth wall body and the first wall body are connected with each other at a second junction. The third wall body and the second wall body are connected with each other at a third junction. The fourth wall body and the second wall body are connected with each other at a fourth junction.

In an embodiment, the platform parts of the plural stopping walls include a first platform part, a second platform part, a third platform part and a fourth platform part. The first platform part is protruded from the first wall body. The second platform part is protruded from the second wall body. The third platform part is protruded from the third wall body. The fourth platform part is protruded from the fourth wall body. There is a first gap between the third platform part and the first platform part. There is a second gap between the fourth platform part and the first platform part. There is a third gap between the third platform part and the second platform part. There is a fourth gap between the fourth platform part and the second platform part. The first gap is located over the first junction. The second gap is located over the second junction. The third gap is located over the third junction. The fourth gap is located over the fourth platform part.

In an embodiment, the keyboard device further includes a supporting plate and a backlight module. The supporting plate is located under the membrane circuit board. The backlight module is located under the supporting plate. The supporting plate is arranged between the backlight module and the membrane circuit board.

In an embodiment, the keyboard device further includes a scissors-type connecting element and an elastic element. The scissors-type connecting element is arranged between the keycap and the supporting plate. A portion of the scissors-type connecting element is enclosed by the plural stopping walls. The elastic element is arranged between the keycap and the membrane circuit board. A portion of the elastic element is enclosed by the plural stopping walls.

From the above description, the present invention provides the keyboard device. The flexible light shielding element is arranged between the keycap and the membrane circuit board. The flexible light shielding element comprises a bottom layer and plural stopping walls. After the light beam from the backlight module is transferred through the supporting plate, the membrane circuit board and the bottom layer of the flexible light shielding element sequentially, the light beam is only allowed to be outputted from the keycap because of the plural stopping walls. That is, only the key structure of the keyboard device is illuminated, but the non-key regions are not illuminated. Moreover, the keycap is contacted with the flexible light shielding element. The flexible light shielding element comprises the plural stopping walls. Each stopping wall comprises a wall body and a platform part. While the external force is applied to the keycap, the keycap is moved downwardly toward the membrane circuit board and the platform parts and the wall bodies of the stopping walls are subjected to deformation. Consequently, the tactile feel of depressing the key structure of the keyboard device is enhanced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the appearance of a keyboard device according to a first embodiment of the present invention;

FIG. 2 is a schematic side view illustrating key structure of the keyboard device as shown in FIG. 1; and

FIG. 3 is a schematic top view illustrating the plural stopping walls of the key structure as shown in FIG. 2.

### DETAILED DESCRIPTION OF THE PREFERRED EMBODIMENT

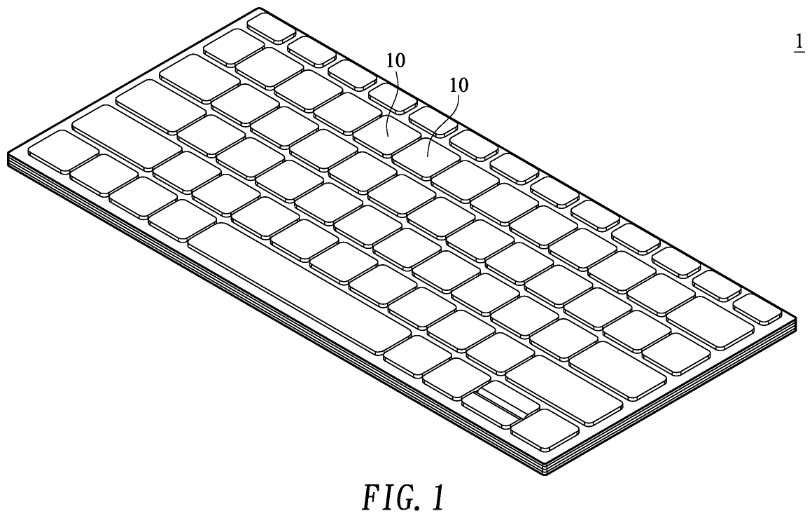

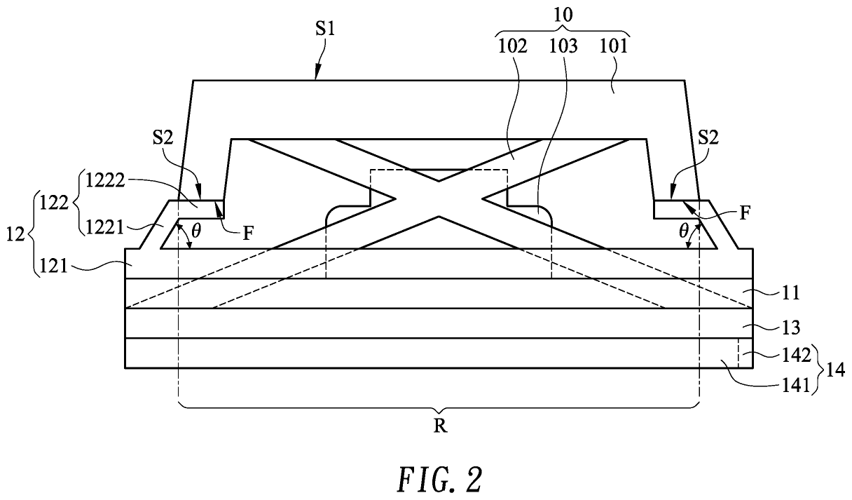

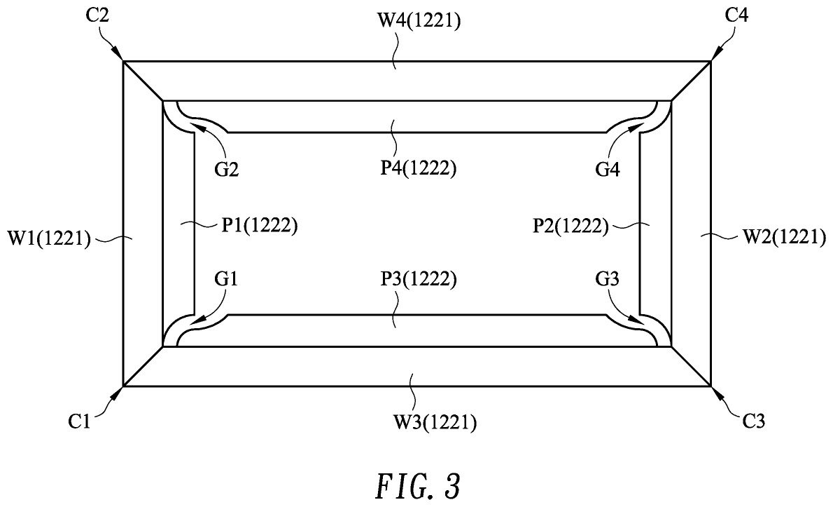

Please refer to FIGS. 1, 2 and 3. FIG. 1 is a schematic perspective view illustrating the appearance of a keyboard device according to a first embodiment of the present invention. FIG. 2 is a schematic side view illustrating key structure of the keyboard device as shown in FIG. 1. FIG. 3 is a schematic top view illustrating the plural stopping walls of the key structure as shown in FIG. 2. As shown in FIGS. 1, 2 and 3, the keyboard device 1 comprises plural key structures 10, a membrane circuit board 11 and a flexible light shielding element 12.

Each key structure 10 of the keyboard device 1 comprises a keycap 101. The keycap 101 has a first end surface 51 and a second end surface S2, which are opposed to each other. The first end surface 51 can be pressed by the user.

The membrane circuit board 11 is located under the keycap 101. When the keycap 11 is depressed by the user, the membrane circuit board 11 is triggered to generate an input signal.

The flexible light shielding element 12 is arranged between the keycap 101 and the membrane circuit board 11. In this embodiment, the flexible light shielding element 12 comprises a bottom layer 121 and plural stopping walls 122. Each stopping wall 122 comprises a wall body 1221 and a platform part 1222. The wall body 1221 of each stopping wall 122 is protruded from the bottom layer 121 and in the direction toward the keycap 101. An included angle θ is formed between the wall body 1221 and the bottom layer 121. That is, the wall body 1221 is an inclined wall body that is inclined relative to the platform part 1222. The platform part 1222 of each stopping wall 122 is protruded from the wall body 1221, and arranged between the second end surface S2 of the keycap 101 and the bottom layer 121. In addition, the platform part 1222 is contacted with the second end surface S2 of the keycap 101.

The structure of the keyboard device 1 will be illustrated in more details as follows.

Please refer to FIGS. 1 and 2 again. The keyboard device 1 further comprises a supporting plate 13 and a backlight module 14. The supporting plate 13 is located under the membrane circuit board 11. The membrane circuit board 11 is arranged between the bottom layer 121 of the flexible light shielding element 12 and the supporting plate 13. Since the membrane circuit board 11 is soft and thin, the supporting plate 13 is located under the membrane circuit board 11 to support the membrane circuit board 11. The backlight module 14 is located under the supporting plate 13. Moreover, the supporting plate 13 is arranged between the backlight module 14 and the membrane circuit board 11. In this embodiment, the backlight module 14 comprises a light guide plate 141 and a light-emitting element 142. The light-emitting element 142 is located beside the light guide plate 141. From top to bottom, the bottom layer 121 of the flexible light shielding element 12, the membrane circuit board 11, the supporting plate 13 and the light guide plate 141 of the backlight module 14 are sequentially arranged in a stack form. Moreover, each of the membrane circuit board 11, the supporting plate 13 and the bottom layer 121 of the flexible light shielding element 12 comprises light-transmissible openings (not shown). The light beam emitted by the light-emitting element 142 of the backlight module 14 can be transmitted through the light-transmissible openings.

Please refer to FIGS. 1 and 2. In this embodiment, each key structure 10 of the keyboard device 1 further comprises a scissors-type connecting element 102 and an elastic element 103. The scissors-type connecting element 102 is arranged between the keycap 101 and the supporting plate 13. A portion of the scissors-type connecting element 102 is enclosed by the stopping walls 122 of the flexible light shielding element 12. The elastic element 103 is arranged between the keycap 101 and the membrane circuit board 11. Moreover, a portion of the elastic element 103 is enclosed by the stopping walls 122 of the flexible light shielding element 12. In this embodiment, the scissors-type connecting element 102 is installed on the supporting plate 13, and the elastic element 103 is installed on the membrane circuit board 11. For example, the supporting plate 13 is equipped with plural hooks (not shown). The scissors-type connecting element 102 is connected with the hooks of the supporting plate 13, and thus the scissors-type connecting element 102 is connected with the supporting plate 13. It is noted that the way of connecting the scissors-type connecting element 102 with the supporting plate 13 is not restricted. That is, the way of connecting the scissors-type connecting element 102 with the supporting plate 13 is not restricted.

As shown in FIG. 2, the bottom layer 121 and the plural stopping walls 122 of the flexible light shielding element 12 are integrally formed as a one-piece structure. In an embodiment, the flexible light shielding element 12 is made of silicon resin with low light transmittance. It is noted that the material of the flexible light shielding element 12 is not restricted as long as the material has the low light transmittance. Moreover, the platform parts 1222 of the stopping walls 122 are included in an orthographic projection region R of the keycap 101 with respect to the bottom layer 121. The wall bodies 1221 of the stopping walls 122 are located outside the orthographic projection region R of the keycap 101 with respect to the bottom layer 121. After the light beam from the light-emitting element 142 of the backlight module 14 is introduced into the light guide plate 141, the light beam is transferred through the light guide plate 141. After the light beam is exited from the light guide plate 141, the light beam is transferred through the supporting plate 13, the membrane circuit board 11 and the bottom layer 121 of the flexible light shielding element 12 sequentially. Then, the light beam is outputted from the keycap 101. Consequently, each key structure 10 of the keyboard device 10 is illuminated. Since the flexible light shielding element 12 is made of the material with the low light transmittance, the light beam is blocked by the stopping walls 122 and the light beam is only allowed to be outputted from the keycap 101. In other words, the light beam is confined to the orthographic projection region R of the keycap 101 with respect to the bottom layer 121. Since the light beam is only allowed to be outputted from the keycap 101, only the key structure 10 of the keyboard device 1 is illuminated. The region of the keyboard device 1 without the key structure 10 (i.e., the region outside the orthographic projection region R) is not illuminated.

Please refer to FIG. 2 again. The platform parts 1222 of the stopping wall 122 have respective contact surfaces F. The contact surfaces F of these platform parts 1222 are in parallel with the second end surface S2 of the keycap 101. Moreover, the contact surfaces F of these platform parts 1222 are contacted with the second end surface S2 of the keycap 101.

In an embodiment, the included angle θ between the wall body 1221 of each stopping wall 122 and the bottom layer 121 is in the range between 30 degrees and 50 degrees. That is, the included angle θ is larger than or equal to 30 degrees and smaller than or equal to 50 degrees. It is noted that the included angle θ is not restricted. For example, in another embodiment, the included angle θ between the wall body 1221 of each stopping wall 122 and the bottom layer 121 is smaller than 30 degrees, for example in the range between 10 degrees and 20 degrees or in the range between 20 degrees and 30.

While an external force is applied to the keycap 101, the keycap 101 is moved downwardly toward the membrane circuit board 11, and the scissors-type connecting element 102 is switched from an open-scissors state to a stacked state. As the keycap 101 is moved downwardly to compress the elastic element 103, the elastic element 103 is subjected to the deformation and the membrane circuit board 11 is triggered. At the same time, the contact surfaces F of the platform parts 1222 of the stopping wall 122 are pressed by the second end surface S2 of the keycap 101. Consequently, the platform parts 1222 and the inclined wall bodies 1221 of the stopping walls 122 are subjected to deformation. Due to the wall bodies 1221 and the platform parts 1222 of the stopping walls 122, the tactile feel of depressing the key structure 10 of the keyboard device 10 is enhanced.

Please refer to FIG. 3. In this embodiment, the wall bodies 1221 of the stopping walls 122 comprise a first wall body W1, a second wall body W2, a third wall body W3 and a fourth wall body W4, which are connected with each other. The first wall body W1 and the second wall body W2 are opposed to each other. The third wall body W3 and the fourth wall body W4 are opposed to each other. The third wall body W3 and the first wall body W1 are connected with each other at a first junction C1. The fourth wall body W4 and the first wall body W1 are connected with each other at a second junction C2. The third wall body W3 and the second wall body W2 are connected with each other at a third junction C3. The fourth wall body W4 and the second wall body W2 are connected with each other at a fourth junction C4.

Please refer to FIG. 3 again. The platform parts 1222 of the stopping walls 122 comprise a first platform part P1, a second platform part P2, a third platform part P3 and a fourth platform part P4. The first platform part P1 is protruded from the first wall body W1. The second platform part P2 is protruded from the second wall body W2. The third platform part P3 is protruded from the third wall body W3. The fourth platform part P4 is protruded from the fourth wall body W4. There is a first gap G1 between the third platform part P3 and the first platform part P1. There is a second gap G2 between the fourth platform part P4 and the first platform part P1. There is a third gap G3 between the third platform part P3 and the second platform part P2. There is a fourth gap G4 between the fourth platform part P4 and the second platform part P2. The first gap G1 is located over the first junction C1. The second gap G2 is located over the second junction C2. The third gap G3 is located over the third junction C3. The fourth gap G4 is located over the fourth platform part P4.

As mentioned above, there is one gap between every two adjacent platform parts 1222. While the external force is applied to the keycap 101, the keycap 101 is moved downwardly toward the membrane circuit board 11 and the platform parts 1222 and the wall bodies 1221 of the stopping walls 122 are subjected to deformation. Due to the gaps between the adjacent platform parts 1222, the deformations of the first platform part P1, the second platform part P2, the third platform part P3 and the fourth platform part P4 are not impeded by each other. Consequently, the tactile feel of depressing the key structure 10 of the keyboard device 10 is enhanced.

In the above embodiment, the flexible light shielding element 12 between the keycap 101 and the membrane circuit board 11 is applied to the keyboard device 1 with the backlight module 14 (i.e., the luminous keyboard). It is noted that the applications of the flexible light shielding element is not restricted. For example, in another embodiment, the flexible light shielding element 12 between the keycap 101 and the membrane circuit board 11 is applied to the keyboard device 1 without the backlight module 14.

From the above description, the present invention provides the keyboard device. The flexible light shielding element is arranged between the keycap and the membrane circuit board. The flexible light shielding element comprises a bottom layer and plural stopping walls. After the light beam from the backlight module is transferred through the supporting plate, the membrane circuit board and the bottom layer of the flexible light shielding element sequentially, the light beam is only allowed to be outputted from the keycap because of the plural stopping walls. That is, only the key structure of the keyboard device is illuminated, but the non-key regions are not illuminated. Moreover, the keycap is contacted with the flexible light shielding element. The flexible light shielding element comprises the plural stopping walls. Each stopping wall comprises a wall body and a platform part. While the external force is applied to the keycap, the keycap is moved downwardly toward the membrane circuit board and the platform parts and the wall bodies of the stopping walls are subjected to deformation. Consequently, the tactile feel of depressing the key structure of the keyboard device is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A keyboard device, comprising:
plural key structures, wherein each of the key structures comprises a keycap, and the keycap has a first end surface and a second end surface, which are opposed to each other;
a membrane circuit board located under the keycap;
a flexible light shielding element arranged between the keycap and the membrane circuit board, and comprising a bottom layer and plural stopping walls, wherein each of the stopping walls comprises a wall body and a platform part, the wall body is protruded from the bottom layer and in a direction toward the keycap, an included angle is formed between the wall body and the bottom layer, the platform part is protruded from the wall body, the platform part is arranged between the second end surface of the keycap and the bottom layer, and the platform part is contacted with the second end surface of the keycap, wherein the bottom layer and the plural stopping walls of the flexible light shielding element are integrally formed as a one-piece structure;
a supporting plate located under membrane circuit board; and
a backlight module located under the supporting plate, wherein the supporting plate is arranged between the backlight module and the membrane circuit board, and the backlight module comprises a light guide plate and a light-emitting element located beside the light guide plate, wherein the platform parts of the plural stopping walls are included in an orthographic projection region of the keycap with respect to the bottom layer, and the wall bodies of the plural stopping walls are located outside the orthographic projection region, so that the light beam emitted by the light-emitting element is confined to the orthographic projection region of the keycap and the region of the keyboard device outside the orthographic projection region of the key structure is not illuminated.

2. The keyboard device according to claim 1, wherein the included angle between the wall body and the bottom layer is in a range between 30 degrees and 50 degrees.

3. The keyboard device according to claim 1, wherein the platform part has a contact surface, and the contact surface is in parallel with the second end surface of the keycap, wherein the contact surface of the platform part is contacted with the second end surface of the keycap.

4. (canceled)

5. The keyboard device according to claim 1, wherein the bottom layer and the plural stopping walls of the flexible light shielding element are integrally formed as a one-piece structure.

6. The keyboard device according to claim 1, wherein the flexible light shielding element is made of silicon resin.

7. The keyboard device according to claim 1, wherein the wall bodies of the plural stopping walls comprise a first wall body, a second wall body, a third wall body and a fourth wall body, which are connected with each other, wherein the first wall body and the second wall body are opposed to each other, the third wall body and the fourth wall body are opposed to each other, the third wall body and the first wall body are connected with each other at a first junction, the fourth wall body and the first wall body are connected with each other at a second junction, the third wall body and the second wall body are connected with each other at a third junction, and the fourth wall body and the second wall body are connected with each other at a fourth junction.

8. The keyboard device according to claim 7, wherein the platform parts of the plural stopping walls comprise a first platform part, a second platform part, a third platform part and a fourth platform part, wherein the first platform part is protruded from the first wall body, the second platform part is protruded from the second wall body, the third platform part is protruded from the third wall body, and the fourth platform part is protruded from the fourth wall body, wherein there is a first gap between the third platform part and the first platform part, there is a second gap between the fourth platform part and the first platform part, there is a third gap between the third platform part and the second platform part, and there is a fourth gap between the fourth platform part and the second platform part, wherein the first gap is located over the first junction, the second gap is located over the second junction, the third gap is located over the third junction, and the fourth gap is located over the fourth platform part.

9. (canceled)

10. The keyboard device according to claim 1, wherein each of the key structures further comprises:
a scissors-type connecting element arranged between the keycap and the supporting plate, wherein a portion of the scissors-type connecting element is enclosed by the plural stopping walls; and
an elastic element arranged between the keycap and the membrane circuit board, wherein a portion of the elastic element is enclosed by the plural stopping walls.
